(19) United States
(12) Patent Application Publication
(10) Pub. No.: US 2013/0058858 A1
(43) Pub. Date: Mar. 7, 2013

(54) POLYACRYLONITRILE POROUS BODY

(71) Applicants: Hiroshi Uyama, Suita-shi (JP); Takashi Tsujimoto, Suita-sh (JP); Keisuke Okada, Suita-shi (JP); Tatsuya Oka, Suita-shi (JP)

(72) Inventors: Hiroshi Uyama, Suita-shi (JP); Takashi Tsujimoto, Suita-sh (JP); Keisuke Okada, Suita-shi (JP); Tatsuya Oka, Suita-shi (JP)

(73) Assignee: OSAKA UNIVERSITY, Suita-shi, Osaka (JP)

(21) Appl. No.: 13/696,133

(22) PCT Filed: May 2, 2011
(86) PCT No.: PCT/JP2011/060515

§ 371 Date: Nov. 5, 2012

(30) Foreign Application Priority Data
May 7, 2010 (JP) 2010-107376

(51) Int. Cl. C08J 9/00; C01B 31/02; C08F 120/44

(52) U.S. Cl. 423/445 R; 521/149; 521/82; 521/88; 521/87; 521/94; 521/89; 521/90

(57) ABSTRACT

A method for producing a porous body containing polyacrylonitrile as a main component, and the method includes the steps of obtaining a polyacrylonitrile solution by heating and dissolving the polyacrylonitrile in a solvent, obtaining a product precipitated by cooling the polyacrylonitrile solution, and obtaining the porous body containing the polyacrylonitrile as a main component by separating and drying the product. The solvent contains a poor solvent for the polyacrylonitrile and a good solvent for the polyacrylonitrile.

### TECHNICAL FIELD

The present invention relates to a porous body containing polyacrylonitrile as a main component.

### BACKGROUND ART

Large quantities of porous bodies are used in various fields as separating agents, adsorbents, and the like. Regarding inorganic porous bodies, extensive research has been carried out on silica-based porous bodies. Techniques to produce porous silica particles among silica-based porous bodies have been generally researched. Such porous silica particles are in practical use as analytical materials. On the other hand, regarding polymeric porous bodies, techniques to obtain porous particles by adding a suitable diluting agent during suspension polymerization of a vinyl monomer are known. Taking advantage of lightweight properties of polymeric materials, such polymeric porous bodies are in practical use as various adsorbents and separating agents.

A mass of a material having a complex structure formed of a continuous skeleton and voids is called a monolith. Regarding silica-based porous bodies, a technique to produce a monolith that is a product having a certain thickness is known. Regarding polymeric porous bodies, a synthesizing technique by a polymerization method has been reported for a vinyl polymer monolith, but it is not yet in practical use because structure control is not easy.

As a polymeric material, polyacrylonitrile (hereinafter sometimes referred to as PAN) is widely used as a component of clothing, packaging materials, separation membranes, and the like. PAN has excellent solvent resistance and strength, and known methods for producing porous bodies using PAN as an ingredient include a method for producing a porous film composed of a resin composition that partially contains PAN (for example, patent literature 1) and a method for producing a PAN porous body in which a dope prepared from an organic solvent in which PAN has been dissolved is solidified using a coagulation bath of a solution composed of the organic solvent and a PAN solidifying agent (for example, patent literature 2).

However, porous bodies obtained by these known techniques are, for example, fibers, and thus a method for producing a porous body containing PAN as a main component is not known.

### PRIOR ART DOCUMENTS

### Patent Document

Patent Document 1: JP 2002-194133A

Patent Document 2: JP H8-22934B

### DISCLOSURE OF INVENTION

### Problem to be Solved by the Invention

Accordingly, an object of the present invention is to provide a method for producing a polyacrylonitrile porous body.

### Means for Solving Problem

The present invention is a method for producing a porous body containing polyacrylonitrile as a main component, and the method includes the steps of

obtaining a polyacrylonitrile solution by heating and dissolving the polyacrylonitrile in a first solvent,

obtaining a product precipitated by cooling the polyacrylonitrile solution, and

obtaining the porous body containing the polyacrylonitrile as a main component by immersing the product in a second solvent to replace the first solvent with the second solvent,

the first solvent containing a poor solvent for the polyacrylonitrile and a good solvent for the polyacrylonitrile.

### Effects of the Invention

The present invention is capable of providing a polyacrylonitrile porous body.

### BRIEF DESCRIPTION OF DRAWINGS

FIG. 1 shows images depicting Example 1.

FIG. 2 is a SEM micrograph of a PAN porous body obtained in Example 1.

FIG. 3(a) is a SEM micrograph of a porous body obtained with PAN in a concentration of 120 mg/mL in Example 2, and FIG. 3(b) is a SEM micrograph of a porous body obtained with PAN in a concentration of 160 mg/mL in Example 2.

FIG. 4 is a SEM micrograph of a calcined porous body obtained in Example 4.

FIG. 5 is a SEM micrograph of a porous body obtained in Example 5.

FIG. 6 is a SEM micrograph of a porous body obtained in Example 6.

FIG. 7(a) is a SEM micrograph of a fiber obtained in a comparative example.

FIG. 7(b) is a SEM micrograph of a fiber obtained in a comparative example.

FIG. 7(c) is a SEM micrograph of a fiber obtained in a comparative example.

FIG. 8 is a SEM micrograph of a porous body obtained in Example 16.

FIG. 9 is a SEM micrograph of a porous body obtained in Example 17.

FIG. 10 is a SEM micrograph of a porous body obtained in Example 18.

FIG. 11 is a SEM micrograph of a porous body obtained in Example 19.

FIG. 12 is a SEM micrograph of a porous body obtained in Example 20.

FIG. 13 is a SEM micrograph of a porous body obtained in Example 21.

FIG. 14 is a SEM micrograph of a porous body obtained in Example 22.

### DESCRIPTION OF EMBODIMENTS

A feature of the porous body of the present invention is that the thickness thereof is greater than that of a fiber or a membrane. The shape of the porous body is not limited, and the smallest dimension in three directions, i.e., length, width and height directions, of the porous body is conveniently referred to as its thickness. The porous body of the present invention has a thickness of for example, 1 mm or greater, preferably 15 mm or greater, and more preferably 2 mm or greater.

Herein, polyacrylonitrile refers to a polymer containing acrylonitrile as a main component in a proportion of for example, 85 wt % or greater, preferably 90 wt % or greater, and more preferably 92 wt % or greater. The polyacrylonitrile can contain acrylonitrile as a main component and a monomer other than acrylonitrile as another component. Another component is not limited as long as it is a monomer other than acrylonitrile, and examples include methyl acrylate, vinyl acetate, and the like. The molecular weight of the polyacrylonitrile is not limited, and the average molecular weight is, for example, 10 thousand to 5 million, preferably 20 thousand to 4 million, and more preferably 30 thousand to 3 million.

In the production method of the present invention, as described above, a polyacrylonitrile solution is obtained by heating and dissolving polyacrylonitrile in the first solvent. The heating temperature is, for example, 70 to 95° C. and preferably 70 to 90° C. Polyacrylonitrile may be dissolved in the first solvent while receiving a physical stimulus. Examples of the physical stimulus include stirring, shaking, ultrasonication, and the like.

As described above, the first solvent contains a poor solvent for polyacrylonitrile and a good solvent for polyacrylonitrile. The poor solvent for polyacrylonitrile and the good solvent for polyacrylonitrile each may be a mixture of two or more solvents. The poor solvent as used herein refers to a solvent whose ability to dissolve polyacrylonitrile is small. Specifically, the term means that no more than 1 g, preferably no more than 0.8 g, and more preferably no more than 0.5 g of polyacrylonitrile dissolves in 1 L of the poor solvent. Also, the good solvent as used herein refers to a solvent whose ability to dissolve polyacrylonitrile is large. Specifically, the term means that no less than 10 g, preferably no less than 15 g, and more preferably no less than 20 g of polyacrylonitrile dissolves in 1 L of the good solvent. The poor solvent for polyacrylonitrile is one or more selected from the group consisting of for example, water, acetonitrile, ethylene glycol, methanol, ethanol, isopropanol, ethylene glycol, and glycerol, and preferably one or more selected from the group consisting of water, acetonitrile, and ethylene glycol. The good solvent for polyacrylonitrile is one or more selected from the group consisting of for example, dimethylsulfoxide, dimethylformamide, dimethylacetamide, and N-methylpyrrolidone, and preferably one or more selected from the group consisting of dimethylsulfoxide and dimethylformamide

The first solvent when being 100 vol % has a good solvent content of for example, 10 to 95 vol %, preferably 20 to 90 vol %, and more preferably 80 to 90 vol %.

The polyacrylonitrile solution has a polyacrylonitrile concentration of for example, 40 to 300 mg/ml, and preferably 50 to 200 mg/ml, and more preferably 60 to 200 mg/ml.

In the production method of the present invention, next, the polyacrylonitrile solution is cooled to obtain a product by precipitation. The cooling temperature is, for example, −20 to 60° C., preferably 15 to 45° C., and more preferably 15 to 40° C. The cooling time is, for example, 1 minute to 24 hours, preferably 1 minute to 1.5 hours, and more preferably 2 minutes to 1 hour.

In the production method of the present invention, next, the product is immersed in a second solvent to replace the first solvent with the second solvent to obtain a porous body containing polyacrylonitrile as a main component.

The second solvent is preferably one or more selected from the group consisting of water, lower alcohols, acetone, and acetonitrile, and more preferably water, methanol, acetone, and acetonitrile. Examples of the lower alcohols include C₁₋₆ lower alcohols such as methanol, ethanol, n-propanol, i-propanol, n-butanol, 2-butanol, i-butanol, t-butanol, n-pentanol, t-amyl alcohol, and n-hexanol.

The present invention is a method for producing, for example, a porous body that contains polyacrylonitrile as a main component and has a thickness of 1 mm or greater, and the method includes the steps of

obtaining a polyacrylonitrile solution by heating and dissolving the polyacrylonitrile at 70 to 95° C. in a first solvent,

obtaining a product precipitated by cooling the polyacrylonitrile solution at −20 to 60° C. for 1 minutes to 24 hours, and

obtaining the porous body containing the polyacrylonitrile as a main component by immersing the product in a second solvent to replace the first solvent with the second solvent,

the first solvent containing a poor solvent for the polyacrylonitrile and a good solvent for the polyacrylonitrile,

the poor solvent being one or more selected from the group consisting of water, acetonitrile, ethylene glycol, methanol, ethanol, isopropanol, ethylene glycol, and glycerol,

the good solvent being one or more selected from the group consisting of dimethylsulfoxide, dimethylformamide, dimethylacetamide, and N-methylpyrrolidone.

After the first solvent is replaced with the second solvent, the obtained product may be dried to obtain a porous body. Drying is carried out at, for example, 0 to 90° C. and preferably 0 to 80° C. Also, drying is carried out, for example, under reduced pressure to ordinary pressure and preferably under reduced pressure. Also, drying may be carried out in the form of freeze drying.

The porous body of the present invention contains polyacrylonitrile as a main component as described above, the porous body has pores having a pore diameter of for example, 0.1 to 15 μm, the pores have a skeletal diameter of for example, 0.05 to 8 μm, and the porous body has a thickness of for example, 1 mm or greater. Such a porous body can be used as, for example, filters, adsorbents, and the like. The pore diameter and the skeletal diameter can be obtained from an image taken with a scanning electron microscope. Note that the porous body that contains polyacrylonitrile as a main component means that polyacrylonitrile accounts for, for example, 85 wt % or greater, preferably 90 wt % or greater, and more preferably 92 wt % or greater of the component polymer of the porous body.

Also, the present invention is directed to a method for producing a carbonized porous body, including the step of calcining a porous body obtained by the method for producing a porous body containing polyacrylonitrile as a main component of the present invention.

Calcination is carried out at, for example, 1000 to 1400° C. and preferably 1100 to 1400° C.

Also, the present invention is directed to a porous body containing polyacrylonitrile as a main component. The porous body has a thickness a for example, 1 mm or greater.

The present invention shall be described in more detail below by way of examples, but the scope of the present invention is not limited to the examples below.

The following abbreviations are used herein.

PAN: polyacrylonitrile

P(AN-MA): poly(acrylonitrile-co-methyl acrylate)

DMF: dimethylformamide

DMSO: dimethylsulfoxide

CH₃CN: acetonitrile

The following measuring instruments were used herein.

Scanning electron microscope: Hitachi S-3000N (manufactured by Hitachi High-Technologies Corporation)

Ion sputter: Hitachi E-1010

BET: Micromeritics Tristar 3000 (manufactured by Shimadzu Corporation)

Sample degassing apparatus: Micromeritics Vacuprep 061LB (manufactured by Shimadzu Corporation)

Digital multimeter: SANWA CD770

Herein, the pore diameter and the skeletal diameter were obtained from an image taken with a scanning electron microscope (SEM).

### Example 1

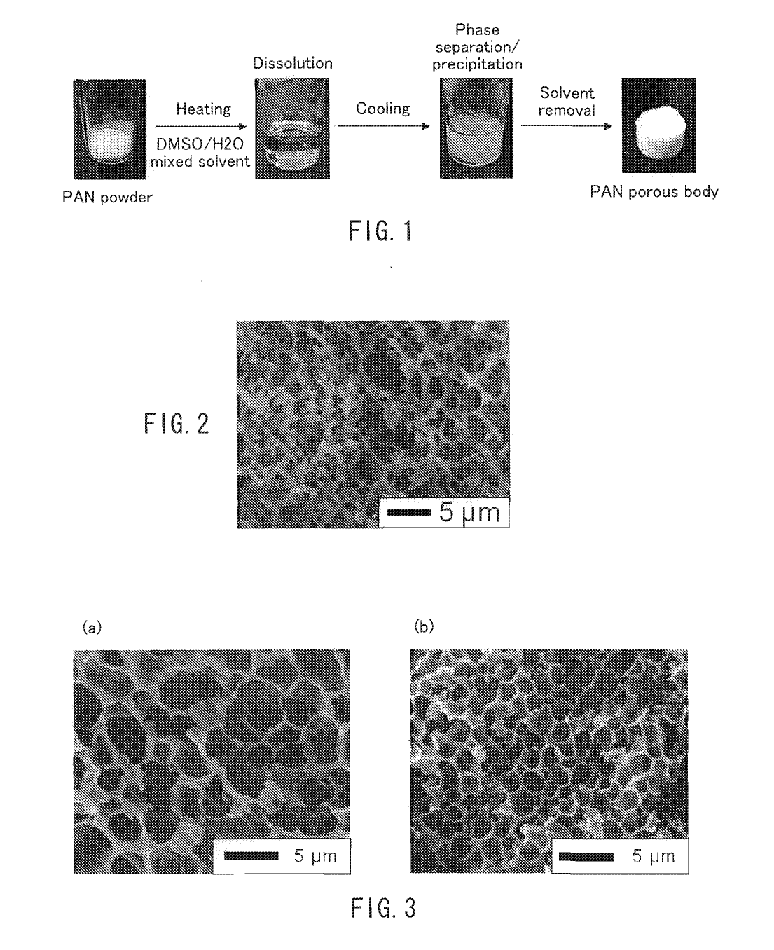

PAN (average molecular weight Mw=150000, manufactured by Aldrich) was added to a DMSO/H₂O (85/15 vol %) mixed solvent in a concentration of 80 mg/ml and stirred at 90° C. After complete dissolution, the stirring bar was removed and the mixture was left to stand still in a water bath at 20° C. for 60 minutes. Phase separation occurred after cooling, thus giving a product having the shape of a sample tube (cylindrical shape) (see FIG. 1). This product was immersed in methanol (second solvent) and shaken in a bioshaker at 20° C. for 24 hours. Methanol was changed 3 times in 24 hours to replace DMSO and water of the solvent with methanol. Thereafter, reduced pressure drying was carried out at ordinary temperatures for 4 hours to remove methanol, thus giving a porous body (dimensions: a substantially cylindrical shape having a diameter of 15 mm and a thickness of 15 mm, PAN accounting for 100 wt % of the component polymer of the porous body).

<SEM Observation>

Sputtering was carried out for 150 s at a discharge current of 15.0 mA, and then SEM observation was carried out at an applied voltage of 15.0 to 25.0 kV.

FIG. 2 shows a SEM micrograph of the obtained porous body. As shown in FIG. 2, it was confirmed that the porous body was a porous body having a co-continuous structure, with the skeletal diameter being 0.4 to 0.6 μm and the pore diameter being 0.8 to 2.1 μm. Note that it was possible to infer that the porous body had a co-continuous structure due to the fact that the shapes of the pores were identical or similar on SEM micrographs of multiple porous body samples.

<BET Specific Surface Area Measurement>

Degassing was carried out in a nitrogen stream at 60° C. for 40 minutes using a sample degassing apparatus, and then a measurement of a specific surface area by the BET three-point method was carried out. The specific surface area obtained by the BET method was 1.6×10² m²/g. It was confirmed from this value that the porous body had a sufficiently large specific surface area.

### Example 2

Porous bodies were obtained in the same manner as in Example 1 except that the PAN concentration was changed to 120 mg/mL and 160 mg/mL (dimensions in the case of a PAN concentration of 120 mg/ml: a substantially cylindrical shape having a diameter of 15 mm and a thickness of 15 mm, a skeletal diameter of 0.4 to 1.0 μm, and a pore diameter of 1.3 to 3.5 μm; and dimensions in the case of a PAN concentration of 160 mg/ml: a substantially cylindrical shape having a diameter of 15 mm and a thickness of 15 mm, a skeletal diameter of 0.2 to 0.5 μm, and a pore diameter of 1.4 to 2.0 μm, PAN accounted for 100 wt % of the polymers constituting both porous bodies). FIG. 3(a) shows a SEM micrograph of the porous body obtained with a PAN concentration of 120 mg/mL, and FIG. 3(b) shows a SEM micrograph of the porous body obtained with a PAN concentration of 160 mg/mL. As shown in FIG. 3, it was confirmed that these porous bodies were porous bodies having honeycomb-like structures.

### Example 3

Porous bodies were obtained in the same manner as in Example 1 except that water, acetone, or acetonitrile was used in place of methanol as the second solvent. In any case, it was confirmed from a SEM observation that PAN porous bodies having a porous structure can be obtained as in the case where methanol was used.

### Example 4

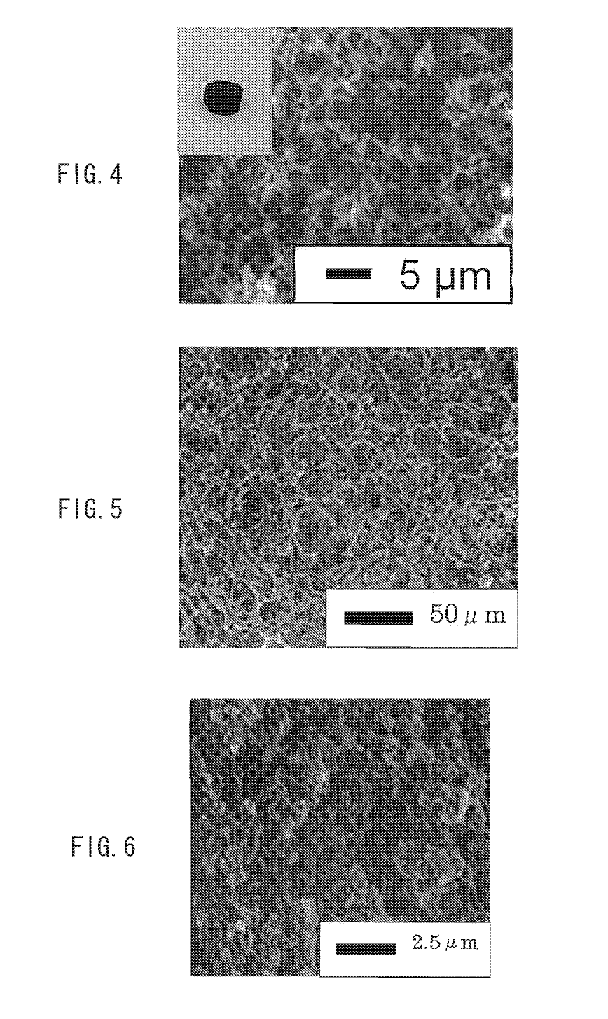

The PAN porous body obtained in Example 1 was, first, heated in highly purified air at 230° C. for 60 minutes. Next, the porous body was heated in a nitrogen atmosphere at a rate of temperature increase of 240° C./h from 25° C. to 1300° C. The diameter and height of the obtained cylindrical porous body were measured using calipers, and the volume was calculated. The weight was measured with an electronic balance. The values of elemental analysis, volume change, weight change, and specific surface area of the obtained porous body are shown in Table 1. FIG. 4 shows a SEM micrograph of the porous body obtained after calcination.

TABLE 1

| | | | | Volume | Weight | Specific |
|---|---|---|---|---|---|---|
| | Elemental analysis (wt %) | | | change | change | surface |
| | C | H | N | (%) | (%) | area (m²/g) |
| Before | 65 | 6 | 24 | 0 | 0 | 169 |
| calcination | | | | | | |
| After | 96 | 1 | 2 | −83 | −60 | 19 |
| calcination | | | | | | |

The specific surface area by the BET method of the calcined porous body was 19 m²/g, which is about 1/9 of the specific surface area before calcination, and this seems to be due to shrinking caused by calcination.

### Example 5

PAN (molecular weight=150000) was added to a DMSO/CH₃CN/H₂O (67/24/9 vol %) mixed solvent in a concentration of 80 mg/ml and stirred at 70° C. After complete dissolution, the stirring bar was removed and the mixture was left to stand still in a water bath at 20° C. for 60 minutes. Phase separation occurred after cooling, thus giving a product having the shape of a container (a cylindrical shape in the case of a sample tube). This product was immersed in methanol (second solvent) and shaken in a bioshaker at 20° C. for 24 hours. Methanol was changed 3 times in 24 hours to replace DMSO, CH₃CN and water of the solvent with methanol. Thereafter, reduced pressure drying was carried out at ordinary temperatures for 4 hours to remove methanol, thus giving a porous body (dimensions: a substantially cylindrical shape having a diameter of 15 mm and a thickness of 15 mm, a skeletal diameter of 1.2 to 3.0 μm, a pore diameter of 3.0 to 7.0 μm, PAN accounting for 100 wt % of the component polymer of the porous body).

FIG. 5 shows a SEM micrograph of the obtained porous body. As shown in FIG. 5, it was confirmed that the porous body was a porous body having a co-continuous structure.

### Example 6

A porous body was obtained in the same manner as in Example 5 except that a DMSO/CH₃CN/H₂O (67/24/9 vol %) mixed solvent was changed to a DMSO/CH₃CN/H₂O (50/40/10 vol %) mixed solvent (dimensions: a substantially cylindrical shape having a diameter of 15 mm and a thickness of 15 mm, a skeletal diameter of 0.2 to 0.3 μm, a pore diameter of 0.2 to 0.3 μm, and PAN accounting for 100 wt % of the component polymer of the porous body). FIG. 6 shows a SEM micrograph of the obtained porous body. As shown in FIG. 6, it was confirmed that the porous body was a porous body having a honeycomb-like structure.

### Comparative Example

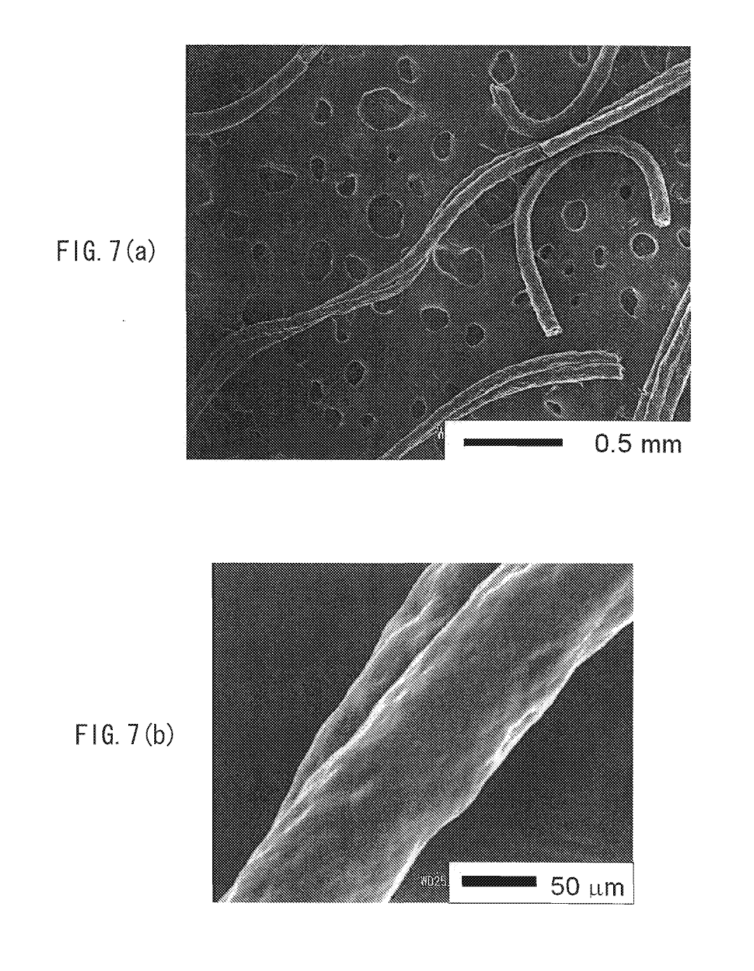

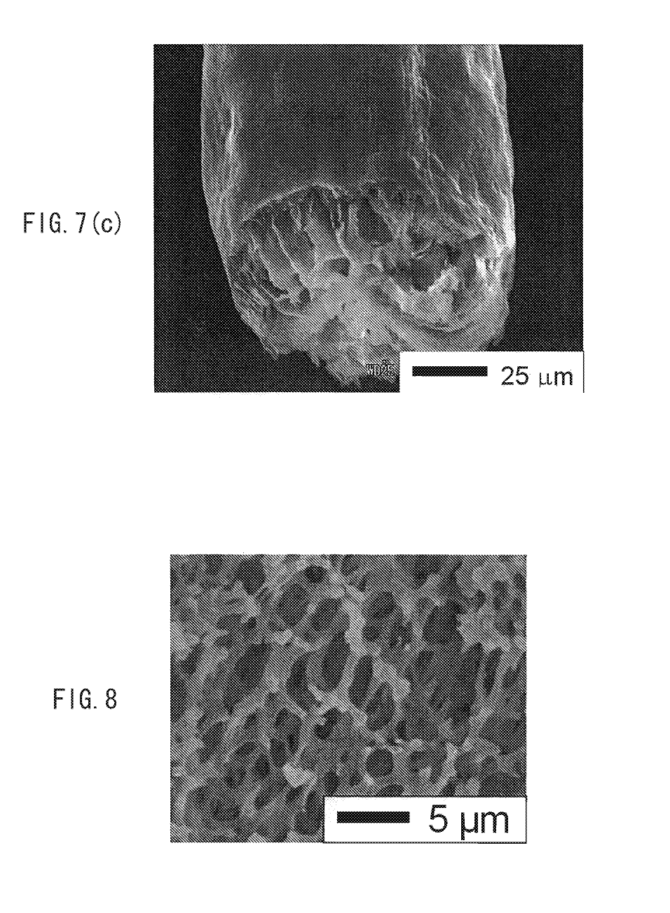

PAN (molecular weight=150000) was dissolved in DMSO at 20° C. to prepare a dope having a concentration of 100 mg/ml. This dope was extruded into a water bath at 20° C. using a syringe (needle size: 30 G). A fiber generated in the water bath was removed, washed with water, and then dried at 20° C. (fiber diameter of 40 μm) FIGS. 7(a) to 7(c) show SEM micrographs of the obtained fiber. As shown in FIG. 7, it was confirmed that the fiber obtained in this manner did not have pores on its surface, and pores were randomly formed inside.

### Example 7

A phase separation product was obtained in the same manner as in Example 1 except that the DMSO/H₂O (85/15 vol %) mixed solvent was changed to a DMF/H₂O (75/25 vol %) mixed solvent and the stirring temperature was changed from 90° C. to 80° C.

### Example 8

A phase separation product was obtained in the same manner as in Example 1 except that the DMSO/H₂O (85/15 vol %) mixed solvent was changed to a DMF/H₂O (80/20 vol %) mixed solvent and the stirring temperature was changed from 90° C. to 80° C.

### Example 9

A phase separation product was obtained in the same manner as in Example 1 except that the DMSO/H₂O (85/15 vol %) mixed solvent was changed to a DMF/H₂O (85/15 vol %) mixed solvent and the stirring temperature was changed from 90° C. to 80° C.

### Example 10

A phase separation product was obtained in the same manner as in Example 1 except that the DMSO/H₂O (85/15 vol %) mixed solvent was changed to a DMF/H₂O (85/15 vol %) mixed solvent, the stirring temperature was changed from 90° C. to 80° C., and the PAN concentration was changed from 80 mg/ml to 120 mg/ml.

### Example 11

A phase separation product was obtained in the same manner as in Example 1 except that the DMSO/H₂O (85/15 vol %) mixed solvent was changed to a DMF/H₂O (90/10 vol %) mixed solvent, the stirring temperature was changed from 90° C. to 70° C., and the PAN concentration was changed from 80 mg/ml to 200 mg/ml.

### Example 12

A phase separation product was obtained in the same manner as in Example 1 except that the DMSO/H₂O (85/15 vol %) mixed solvent was changed to a DMSO/CH₃CN (20/80 vol %) mixed solvent and the stirring temperature was changed from 90° C. to 70° C.

### Example 13

A phase separation product was obtained in the same manner as in Example 1 except that the DMSO/H20 (85/15 vol %) mixed solvent was changed to a DMSO/CH₃CN (30/70 vol %) mixed solvent and the stirring temperature was changed from 90° C. to 70° C.

### Example 14

A phase separation product was obtained in the same manner as in Example 1 except that the DMSO/H₂O (85/15 vol %) mixed solvent was changed to a DMSO/ethylene glycol (70/30 vol %) mixed solvent and the stirring temperature was changed from 90° C. to 70° C.

### Example 15

A phase separation product was obtained in the same manner as in Example 1 except that the DMSO/H₂O (85/15 vol %) mixed solvent was changed to a DMSO/ethylene glycol (80/20 vol %) mixed solvent and the stirring temperature was changed from 90° C. to 70° C.

### Example 16

PAN (molecular weight=150000) was added to a DMSO/H₂O (90/10 vol %) mixed solvent in a concentration of 80 mg/ml and stirred at 70° C. After complete dissolution, the stirring bar was removed and the mixture was left to stand still in a water bath at 20° C. for 60 minutes. Phase separation occurred after cooling, thus giving a product having the shape of a container (a cylindrical shape in the case of a sample tube). This product was immersed in water (second solvent) and shaken in a bioshaker at 20° C. for 24 hours. Water was changed 3 times in 24 hours to replace DMSO of the solvent with water. Thereafter, freeze drying was carried out at ordinary temperatures for 24 hours to remove water, thus giving a porous body (dimensions: a substantially cylindrical shape having a diameter of 15 mm and a thickness of 15 mm). FIG. 8 shows a SEM micrograph of the obtained porous body. As shown in FIG. 8, it was confirmed that the porous body was a porous body having a co-continuous structure, with the skeletal diameter being 0.5 to 10 μm and the pore diameter being 0.8 to 2.2 μm. Note that PAN accounted for 100 wt % of the component polymer of the porous body.

### Example 17

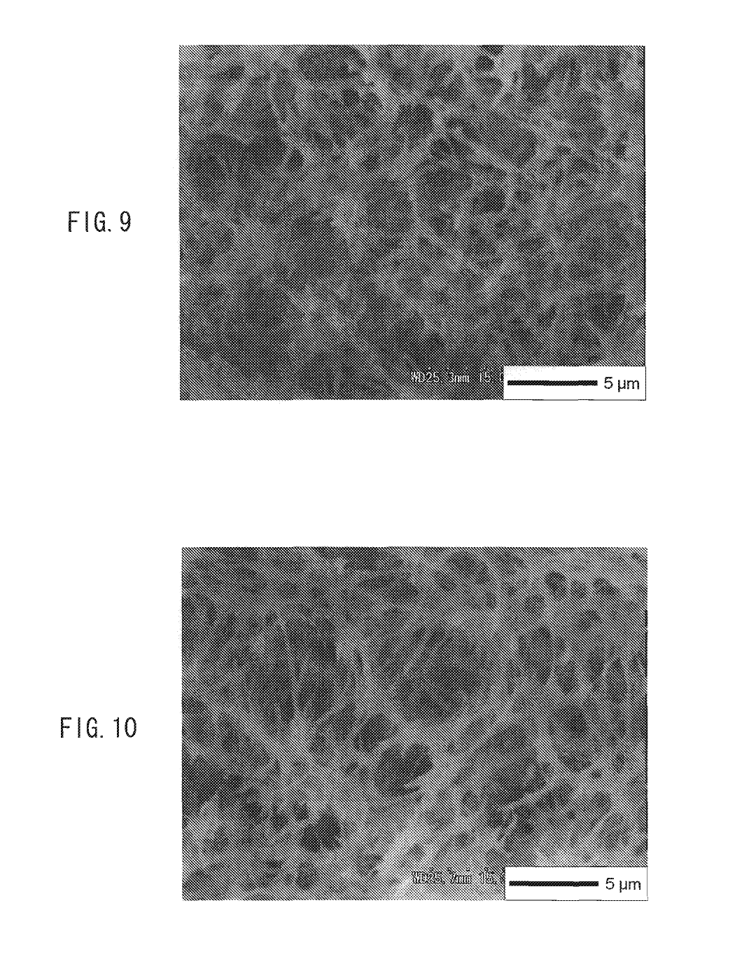

P(AN-MA) (acrylonitrile content of 94 wt % or greater, manufactured by Aldrich) was added to a DMSO/H₂O (85/15 vol %) mixed solvent in a concentration of 50 mg/ml and stirred at 90° C. After complete dissolution, the stirring bar was removed and the mixture was left to stand still in a water bath at 20° C. for 60 minutes. Phase separation occurred after cooling, thus giving a product having the shape of a sample tube (cylindrical shape) (see FIG. 9). This product was immersed in methanol (second solvent) and shaken in a bioshaker at 20° C. for 24 hours. Methanol was changed 3 times in 24 hours to replace DMSO and water of the solvent with methanol. Thereafter, reduced pressure drying was carried out at ordinary temperatures for 4 hours to remove methanol, thus giving a porous body (dimensions: a substantially cylindrical shape having a diameter of 15 mm and a thickness of 15 mm, a skeletal diameter of 0.32 to 0.72 μm, a pore diameter of 0.70 to 1.82 μm, and P(AN-MA) accounting for 100 wt % of the component polymer of the porous body).

FIG. 9 shows a SEM micrograph of the obtained porous body. As shown in FIG. 9, it was confirmed that the porous body was a porous body having a co-continuous structure.

### Example 18

A porous body was obtained in the same manner as in Example 17 except that the P(AN-MA) concentration was changed to 100 mg/mL (dimensions: a substantially cylindrical shape having a diameter of 15 mm and a thickness of 15 mm, a skeletal diameter of 0.31 to 0.77 μm, and a pore diameter of 0.87 to 2.25 μm, P(AN-MA) accounting for 100 wt % of the component polymer of the porous body). FIG. 10 shows a SEM micrograph of the obtained porous body. As shown in FIG. 10, it was confirmed that the porous body was a porous body having a co-continuous structure.

### Example 19

P(AN-MA) (acrylonitrile content of 94 wt % or greater, manufactured by Aldrich) was added to a DMSO/CH₃CN/H₂O (50/40/10 vol %) mixed solvent in a concentration of 50 mg/ml and stirred at 85° C. After complete dissolution, the stirring bar was removed and the mixture was left to stand still in a water bath at 20° C. for 60 minutes. Phase separation occurred after cooling, thus giving a product having the shape of a container (a cylindrical shape in the case of a sample tube). This product was immersed in methanol (second solvent) and shaken in a bioshaker at 20° C. for 24 hours. Methanol was changed 3 times to replace DMSO, CH₃CN and water of the solvent with methanol. Thereafter, reduced pressure drying was carried out at ordinary temperatures for 4 hours to remove methanol, thus giving a porous body (dimensions: a substantially cylindrical shape having a diameter of 15 mm and a thickness of 15 mm, a skeletal diameter of 0.46 to 1.01 μm, a pore diameter of 1.00 to 2.67 μm, P(AN-MA) accounting for 100 wt % of the component polymer of the porous body).

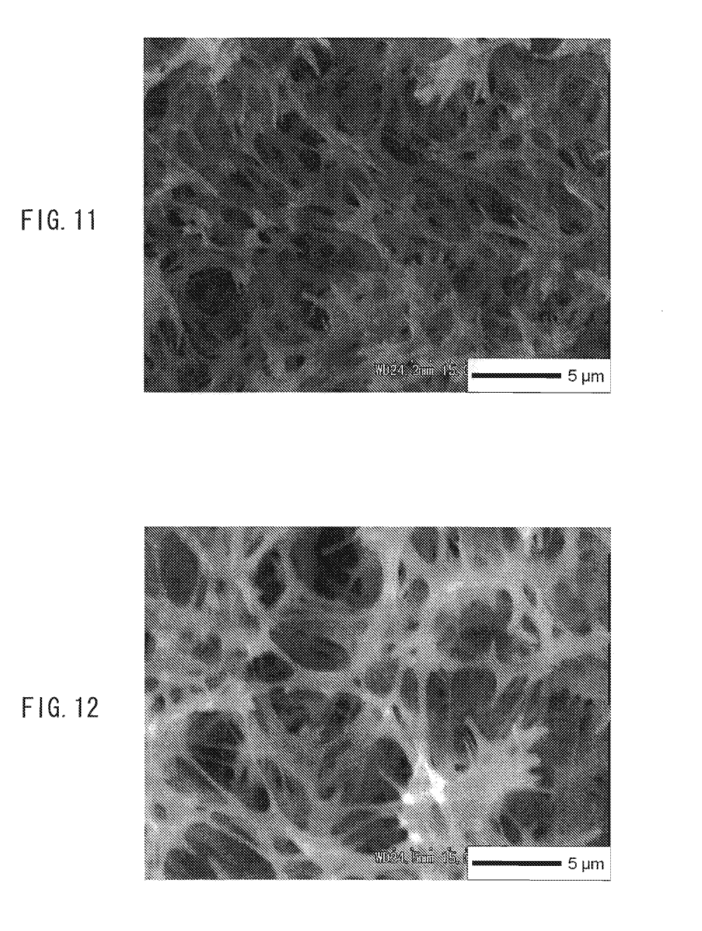

FIG. 11 shows a SEM micrograph of the obtained porous body. As shown in FIG. 11, it was confirmed that the porous body was a porous body having a co-continuous structure.

### Example 20

A porous body was obtained in the same manner as in Example 19 except that a DMSO/CH₃CN/H₂O (50/40/10 vol %) mixed solvent was changed to a DMSO/CH₃CN/H20 (65/25/10 vol %) mixed solvent (dimensions: a substantially cylindrical shape having a diameter of 15 mm and a thickness of 15 mm, a skeletal diameter of 0.41 to 1.26 μm, a pore diameter of 0.96 to 3.52 μm, and P(AN-MA) accounting for 100 wt % of the component polymer of the porous body). FIG. 12 shows a SEM micrograph of the obtained porous body. As shown in FIG. 12, it was confirmed that the porous body was a porous body having a co-continuous structure.

### Example 21

A phase-separation product was obtained in the same manner as in Example 17 except that a DMSO/H₂O (85/15 vol %) mixed solvent was changed to a DMF/H₂O (80/20 vol %) mixed solvent (dimensions: a substantially cylindrical shape having a diameter of 15 mm and a thickness of 15 mm, a skeletal diameter of 0.47 to 0.94 μm, a pore diameter of 1.31 to 2.45 μm, and P(AN-MA) accounting for 100 wt % of the component polymer of the porous body). P(AN-MA) accounted for 100 wt % of the component polymer of the porous body.

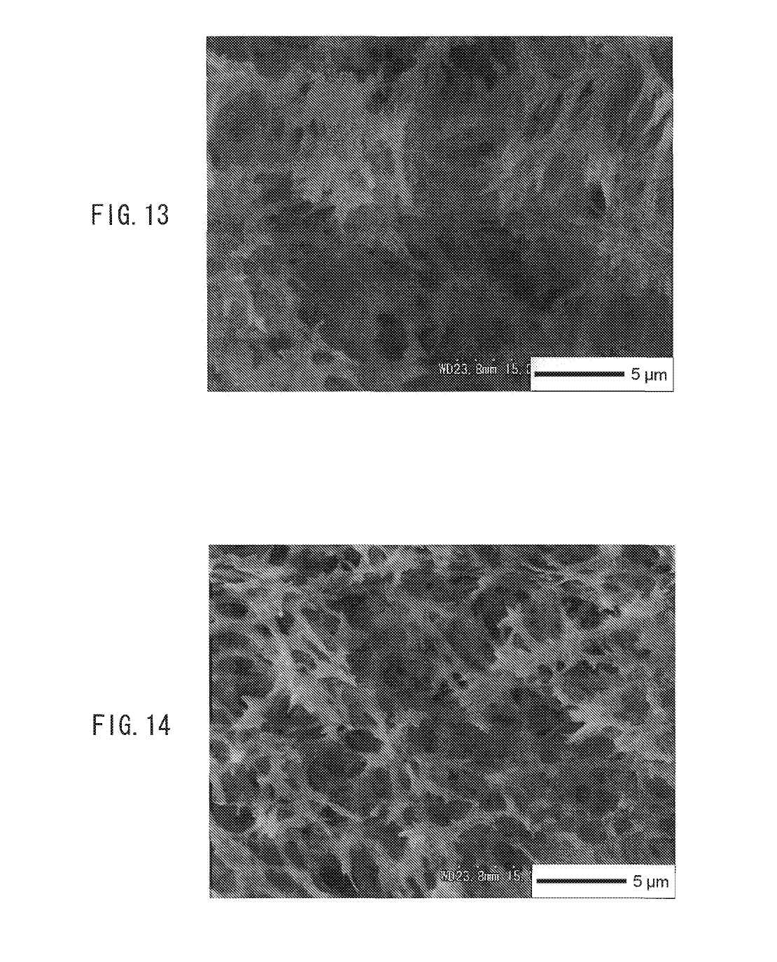

FIG. 13 shows a SEM micrograph of the obtained porous body. As shown in FIG. 13, it was confirmed that the porous body was a porous body having a co-continuous structure.

### Example 22

A phase-separation product was obtained in the same manner as in Example 17 except that a DMSO/H₂O (85/15 vol %) mixed solvent was changed to a DMF/H₂O (85/15 vol %) mixed solvent (dimensions: a substantially cylindrical shape having a diameter of 15 mm and a thickness of 15 mm, a skeletal diameter of 0.49 to 1.12 μm, a pore diameter of 1.17 to 2.26 μm, and P(AN-MA) accounting for 100 wt % of the component polymer of the porous body). P(AN-MA) accounted for 100 wt % of the component polymer of the porous body.

FIG. 14 shows a SEM micrograph of the obtained porous body. As shown in FIG. 14, it was confirmed that the porous body was a porous body having a co-continuous structure.

### INDUSTRIAL APPLICABILITY

The PAN porous body obtained by the method of the present invention has continuous pores, and is possibly applicable to filters, adsorbents, and the like. Also, a carbonized product of the PAN porous body obtained by the method of the present invention retains a co-continuous structure, and is possibly applicable to adsorbents that use its hydrophobicity, a π-π interaction caused by the graphite structure, or the like. Also, it is hoped that the carbonized product is used for battery materials such as electrodes by taking advantage of the features of a porous carbon material.

1. A method for producing a porous body containing polyacrylonitrile as a main component, the method comprising the steps of:
obtaining a polyacrylonitrile solution by heating and dissolving the polyacrylonitrile in a first solvent,
obtaining a product precipitated by cooling the polyacrylonitrile solution, and
obtaining the porous body containing the polyacrylonitrile as a main component by immersing the product in a second solvent to replace the first solvent with the second solvent,
the first solvent containing a poor solvent for the polyacrylonitrile and a good solvent for the polyacrylonitrile.

2. The production method according to claim 1, wherein the second solvent is one or more selected from the group consisting of water, lower alcohols, acetone, and acetonitrile.

3. The production method according to claim 1 or 2, wherein the first solvent when being 100 vol % has a good solvent content of 10 to 95 vol %.

4. The production method according to claim 1, wherein
the poor solvent is one or more selected from the group consisting of water, acetonitrile, ethylene glycol, methanol, ethanol, isopropanol, ethylene glycol, and glycerol, and
the good solvent is one or more selected from the group consisting of dimethylsulfoxide, dimethylformamide, dimethylacetamide, and N-methylpyrrolidone.

5. The production method according to claim 1, wherein the polyacrylonitrile solution has a polyacrylonitrile concentration of 40 to 300 mg/ml.

6. The production method according to claim 1, further comprising, in the step of obtaining the porous body containing the polyacrylonitrile as a main component, a sub-step of drying under reduced pressure the product obtained after the first solvent is replaced by the second solvent.

7. A method for producing a carbonized porous body, comprising the step of calcining a porous body obtained by a production method of claim 1.

8. A porous body comprising polyacrylonitrile as a main component.
